(19) United States
(12) Patent Application Publication
(10) Pub. No.: US 2007/0093128 A1
(43) Pub. Date: Apr. 26, 2007

(54) Coaxial cable connector having collar with cable gripping features

(75) Inventors: Charles E. Thomas, Athens, PA (US); Brian T. Thayer, Bridgeport, NY (US)

Correspondence Address: HOFFMANN & BARON, LLP, 6900 JERICHO TURNPIKE, SYOSSET, NY, 11791, US

(73) Assignee: Thomas & Betts International, Inc.

(21) Appl. No.: 11/581,129

(22) Filed: Oct. 13, 2006

Related U.S. Application Data
(60) Provisional application No. 60/728,495, filed on Oct. 20, 2005.

(51) Int. Cl. H01R 9/05

(52) U.S. Cl. 439/578

(57) ABSTRACT

A coaxial cable connector includes a collar and an axially movable locking sleeve coupled to the collar. The collar has a sleeve insertion end and at least one flexible finger for gripping a cable provided on the sleeve insertion end. The locking sleeve includes an internal ramped surface for deflecting the flexible finger of the collar radially inward to grip the cable as the locking sleeve is moved axially with respect to the collar.

### CROSS-REFERENCE TO RELATED APPLICATIONS

This application claims the benefit of U.S. Provisional Application No. 60/728,495, filed on Oct. 20, 2005.

### FIELD OF THE INVENTION

The present invention relates generally to connectors for terminating coaxial cable. More particularly, the present invention relates to a coaxial cable connector having a collar provided with structure to enhance gripping of a coaxial cable.

### BACKGROUND OF THE INVENTION

It has long been known to use connectors to terminate coaxial cable so as to connect a cable to various electronic devices such as televisions, radios and the like. Prior art coaxial connectors generally include a connector body having an annular collar for accommodating a coaxial cable, an annular nut rotatably coupled to the collar for providing mechanical attachment of the connector to an external device and an annular post interposed between the collar and the nut. A resilient sealing O-ring may also be positioned between the collar and the nut at the rotatable juncture thereof to provide a water resistant seal thereat. The collar includes a cable receiving end for insertably receiving an inserted coaxial cable and, at the opposite end of the connector body, the nut includes an internally threaded end extent permitting screw threaded attachment of the body to an external device.

This type of coaxial connector further includes a locking sleeve to secure the cable within the body of the coaxial connector. The locking sleeve, which is typically formed of a resilient plastic, is securable to the connector body to secure the coaxial connector thereto. In this regard, the connector body typically includes some form of structure to cooperatively engage the locking sleeve. Such structure may include one or more recesses or detents formed on an inner annular surface of the connector body, which engages cooperating structure formed on an outer surface of the sleeve. A coaxial cable connector of this type is shown and described in commonly owned U.S. Pat. No. 6,530,807.

Conventional coaxial cables typically include a center conductor surrounded by an insulator. A conductive foil is disposed over the insulator and a braided conductive shield surrounds the foil covered insulator. An outer insulative jacket surrounds the shield. In order to prepare the coaxial cable for termination, the outer jacket is stripped back exposing an extent of the braided conductive shield which is folded back over the jacket. A portion of the insulator covered by the conductive foil extends outwardly from the jacket and an extent of the center conductor extends outwardly from within the insulator. Upon assembly to a coaxial cable, the annular post is inserted between the foil covered insulator and the conductive shield of the cable.

A problem with current coaxial connectors is that they are often difficult to use with smaller diameter coaxial cables. In particular, current coaxial connectors often do not adequately grip smaller diameter coaxial shielded cables. Moreover, sealing the interior of the connector from outside elements also becomes more challenging with smaller diameter cables.

Accordingly, it would be desirable to provide a coaxial cable connector with structural features to enhance gripping and sealing, particularly with smaller diameter cables.

### OBJECTS AND SUMMARY OF THE INVENTION

It is an object of the present invention to provide a coaxial cable connector for terminating a coaxial cable.

It is a further object of the present invention to provide a coaxial cable having structure to enhance gripping of a coaxial cable, especially a small diameter coaxial cable.

In the efficient attainment of these and other objects, the present invention provides a coaxial cable connector. The connector of the present invention generally includes a collar and an axially movable locking sleeve coupled to the collar. The collar has a sleeve insertion end and at least one flexible finger for gripping a cable provided on the sleeve insertion end. The locking sleeve includes an internal ramped surface for deflecting the flexible finger of the collar radially inward to grip the cable as the locking sleeve is moved axially with respect to the collar.

In a preferred embodiment, the coaxial cable connector of the present invention further includes an annular post disposed within the connector body and a nut rotatably coupled to the post. The collar further preferably includes an outer sleeve engagement surface and the locking sleeve includes an inner collar engagement surface cooperating with the outer sleeve engagement surface of the collar to permit axial movement of the sleeve from a first position, wherein a cable is loosely retained in the connector, to a second position, wherein a cable is secured in the connector. The outer sleeve engagement surface of the collar preferably includes first and second raised protrusions and the inner collar engagement surface preferably includes a groove. The first protrusion of the collar is seated in the groove when the sleeve is in the first position and the second protrusion of the collar is seated in the groove when the sleeve is in the second position.

A preferred form of the coaxial connector, as well as other embodiments, objects, features and advantages of this invention, will be apparent from the following detailed description of illustrative embodiments thereof, which is to be read in conjunction with the accompanying drawings.

### BRIEF DESCRIPTION OF THE DRAWINGS

FIG. 1 is a cross-sectional view of the coaxial cable connector of the present invention in an open position.

FIG. 2 is a cross-sectional view of the connector shown in FIG. 1 in a closed position.

FIG. 3 is a cross-sectional view of the connector shown in FIG. 1 in a closed position with a cable secured thereto.

FIG. 4 is a top perspective view of the connector shown in FIG. 1 with the locking sleeve removed.

### DETAILED DESCRIPTION OF THE PREFERRED EMBODIMENTS

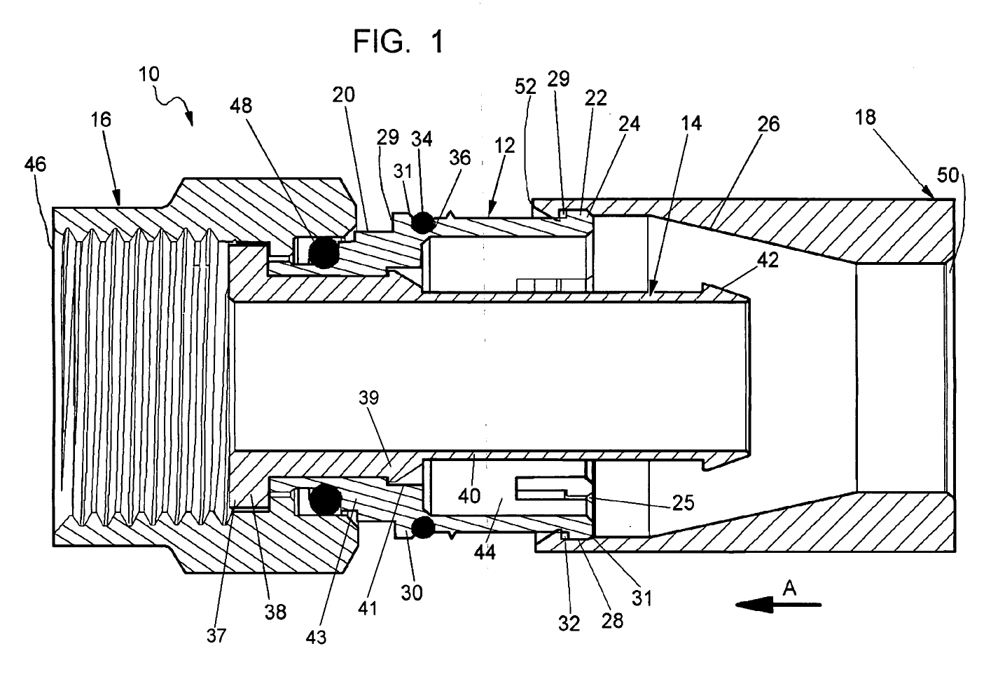

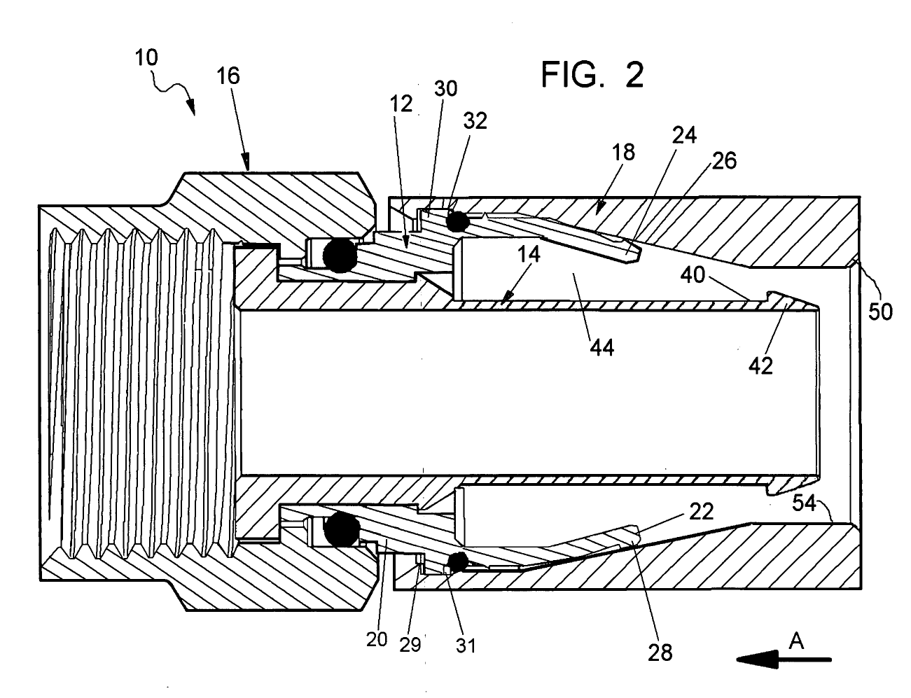

Referring first to FIGS. 1 and 2, the coaxial cable connector 10 of the present invention is shown. The connector 10 generally includes four components: a connector body or collar 12; an annular post 14; a rotatable nut 16; and an axially movable locking sleeve 18. It is however conceivable that the collar 12 and the post 14 can be integrated into one component and/or another fastening device other than the rotatable nut 16 can be utilized.

The collar 12 is an elongate generally cylindrical member, which is preferably made from a resilient plastic material. Alternatively, the collar 12 may be made from a resilient or spring metal or the like. The collar 12 has a forward end 20 coupled to the post 14 and the nut 16 and an opposite rearward sleeve insertion end 22 for insertion into the sleeve 18.

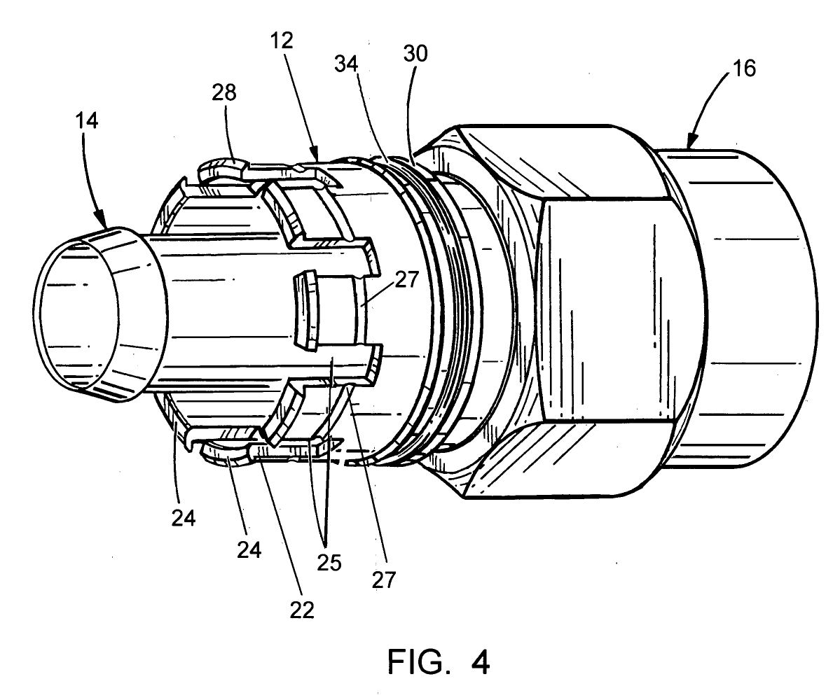

Referring additionally to FIG. 4, the rearward sleeve insertion end 22 of the collar 12 is formed with a plurality of flexible fingers 24 extending in the rearward direction. As will be discussed in further detail below, these fingers 24 are forced to deflect radially inwardly by an internal ramp portion 26 of the locking sleeve 18 during insertion of the collar 12 into the sleeve. As the fingers 24 are deflected inward, they engage the outer jacket of a cable to enhance the gripping of the cable within the connector 10. The fingers 24 may be formed simply by providing longitudinal slots or recesses 25 in the rearward end 22 of the collar 12. A lateral groove 27 may also be provided to increase flexibility of the fingers 24.

The outer cylindrical surface of the collar 12 defines an engagement surface for engaging the locking sleeve 18, as will be described in further detail below. This engagement surface may be adapted to simply frictionally engage and secure the sleeve 18, or it may be provided with structure, such as detents, grooves or protrusions, which cooperate with corresponding structure provided on the sleeve 18. In the preferred embodiment, the collar 12 includes a first raised protrusion 28 formed on the outer surface of the collar at the rearward sleeve insertion end 22 and a second raised protrusion 30 formed on the outer surface of the collar and spaced forward a distance from the first protrusion.

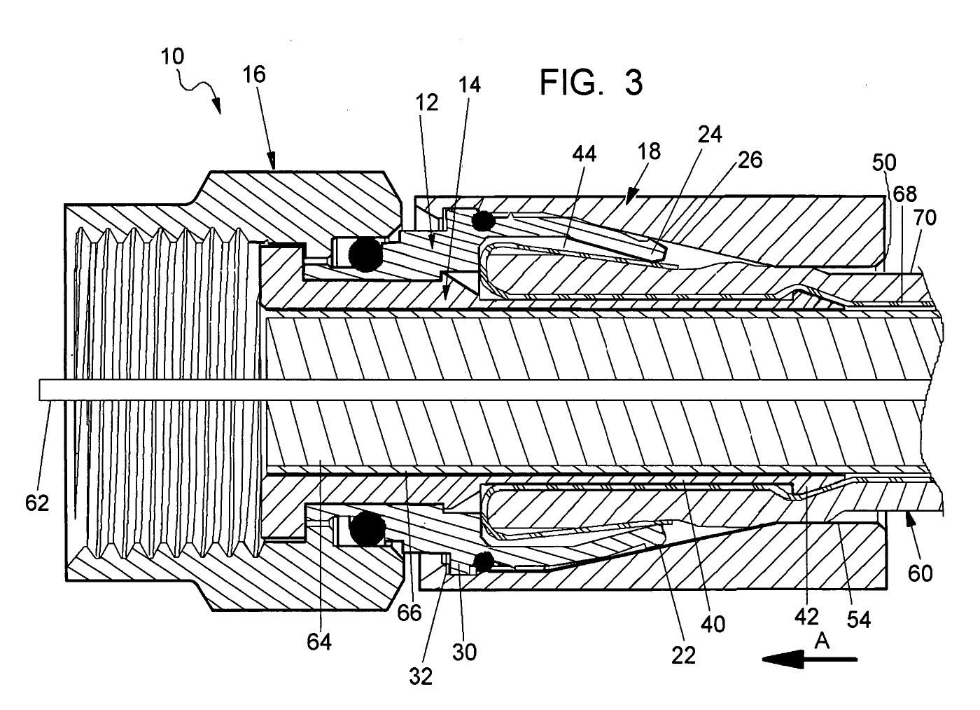

The inner cylindrical surface of the locking sleeve 18 preferably includes a correspondingly sized detent or groove 32 formed therein to receive the first and second protrusions 28 and 30 of the collar 12. The first protrusion 28 of the collar 12 rests in the groove 32 of the locking sleeve 18 when the locking sleeve is in a first “open” position, as shown in FIG. 1, and the second protrusion 30 rests in the groove when the locking sleeve is in a second “closed” position, as shown in FIGS. 2 and 3.

Each protrusion 28 and 30 is further preferably defined by a forwardly facing perpendicular wall 29 and a rearwardly facing chamfered wall 31. This structure facilitates rearward insertion of the collar 12 into the locking sleeve 18 in the direction opposite of arrow A and resists forward removal of the collar from the sleeve.

The collar 12 is further preferably provided with an O-ring 34 to provide a water-tight seal between the collar and the locking sleeve 18 when the sleeve is in its closed position. The O-ring 34 may be seated in a groove 36 formed in the outer surface of the collar 12 between the first and second protrusions 28 and 30.

The annular post 14 includes a flanged base portion 38 and a widened shoulder portion 39 disposed rearward of the base portion, which provides for securement of the collar 12 and post within a post receiving space 37 in the nut 16. In particular, the nut 16 is formed with a post receiving groove or space 37 for receiving the flanged base portion 38 of the post 14. Upon assembly, the post 14 is first slipped into the nut 16 so that the flanged base portion 38 is received within the post receiving space 37 of the nut. The rearward end of the post 14, with the nut 16 thus retained at its forward end, is then inserted into the forward end 20 of the collar 12 until the post shoulder portion 39 is snap-fit into an internal groove 41 formed in the collar. The collar 12 further includes a flange portion 43, which abuts against the nut 16 to prevent forward movement of the collar and post 14 with respect to the nut 16. In this manner, the collar 12, the post 14 and the nut 16 are retained together.

The annular post 14 further includes an annular tubular extension 40 extending within the collar 12 and into the sleeve 18. The distal end of the tubular extension 40 preferably includes a radially outwardly extending ramped flange portion or “barb” 42 for compressing the outer jacket of the coaxial cable against the internal diameter of the locking sleeve 18 to secure the cable within the connector. Alternatively, and/or depending on the method of forming the post 14, the barb 42 may be more rounded as opposed to a ramped flange. In any event, as will be described in further detail hereinbelow, the extension 40 of the post 14, the collar 12 and the sleeve 18 define an annular chamber 44 for accommodating the jacket and shield of the inserted coaxial cable.

The nut 16 may be in any form, such as a hex nut, knurled nut, wing nut, or any other known attaching means, and is rotatably coupled to the collar 12 and the post 14 for providing mechanical attachment of the connector 10 to an external device. The nut 16 includes an internally threaded end extent 46 permitting screw threaded attachment of the connector 10 to the external device. The sleeve 18 and the internally threaded end extension 46 define opposite ends of the connector 10. A resilient sealing O-ring 48 may be positioned between the collar 12 and the nut 16 at the rotatable juncture thereof to provide a water resistant seal thereat.

The locking sleeve 18 is a generally tubular member having a rearward cable receiving end 50 and an opposite forward collar insertion end 52, which is movably coupled to the outer surface of the collar 12, as described above. The locking sleeve 18 is axially moveable along arrow A towards nut 16 from a first position shown in FIG. 1, which loosely retains a cable within the connector 10, to a more forward second position shown in FIGS. 2 and 3, which secures the cable within the connector.

The connector 10 of the present invention is constructed so as to be supplied in the assembled condition shown in FIG. 1, wherein the rearward protrusion 28 of the collar 12 is seated within the groove 32 of the locking sleeve 18 to secure the sleeve in its first position. In such assembled condition, and as will be described in further detail hereinbelow, a coaxial cable may be inserted through the rearward cable receiving end 50 of the sleeve 18. The sleeve 18 may then be moved from the first position loosely retaining the cable to the second position which is axially forward thereby locking the cable within the connector.

It is however contemplated that the sleeve 18 may be provided separately from the rest of the connector 10, which, in a manner which will be described in further detail hereinbelow, will allow the coaxial cable to be first inserted directly into the post 14 unobstructed by the sleeve 18. Thereafter, the sleeve 18, which has been earlier placed around the cable, may be attached to the collar 12 where it can be moved from the first position to the second position locking the cable within the connector.

Having described the components of the connector 10 in detail, the use of the connector in terminating a coaxial cable may now be described with respect to FIG. 3. Coaxial cable 60 includes an inner conductor 62 formed of copper or similar conductive material. Extending around the inner conductor 62 is an insulator 64 formed of a suitably insulative plastic. A metallic foil 66 is disposed over the insulator 64 and a metallic shield 68 is positioned in surrounding relationship around the foil covered insulator. Covering the metallic shield 68 is an outer insulative jacket 70.

Cable 60 is prepared in conventional fashion for termination by stripping back the jacket 70 exposing an extent of shield 68. A portion of the foil covered insulator 64 extends therefrom with an extent of conductor 62 extending from insulator 64. After an end extent of shield 68 is folded back about jacket 70, the cable 60 may be inserted into the connector 10 with the sleeve 18 already coupled to the collar 12, as shown in FIG. 1. In this technique, the prepared cable 60 is inserted through the rearward end 50 of the sleeve 18 and the barb 42 of the post 14 is inserted between the foil 66 covering the insulator 64 and the metallic shield 68 such that the shield and the jacket 70 reside within the annular region 44 defined between the post 14 and the collar 12. When the sleeve 18 is coupled to the collar 12 in the first position, as shown in FIG. 1, sufficient clearance is provided between the sleeve and the post 14 so that the barb 42 may be easily interposed between the foil 66 and the shield 68 of the cable 60.

Once the cable 60 is properly inserted, the sleeve 18 may be moved axially forward in the direction of arrow A from the first position shown in FIG. 1, to the second position shown in FIGS. 2 and 3. When the sleeve 18 is moved axially forward, the rearward protrusion 28 of the collar 12 disengages the groove 32 formed in the sleeve. Such movement is facilitated by the rearward facing chamfered wall 31 of the rearward protrusion 28. The sleeve 18 is moved axially forward until the forward protrusion 30 of the collar 12 comes to rest in the groove 32 formed in the sleeve. A suitable compression tool may be used to effect movement of the sleeve 18 from its first position to its second position securing the cable 60 to the connector 10.

In certain installation settings, it may be difficult for the installer to blindly insert the cable 60 through the cable receiving end 50 of the sleeve 18 while the sleeve is connected to the collar 12. In such situations, the present invention contemplates the ability to detachably remove the sleeve 18 from the collar 12 so that the cable 60 may be directly connected to the tubular extension 40 of the post 14.

In these situations, the sleeve 18 is detachably removed from the collar 12 and is slipped over the cable 60 and moved to a convenient position along the cable length. The end of the foil covered insulator 64 may then be inserted directly into the post extension 40 so that the extension is interposed between the foil 66 covering the insulator 64 and the shield 68. Thereafter, the sleeve 18 may be brought up along the cable 60 and the rearward insertion end 22 of the collar 12 may be inserted into the collar receiving end 52 of the sleeve 18. Thereafter, as described above, the sleeve 18 may be moved from the first position shown in FIG. 1 to its second position shown in FIGS. 2 and 3.

In either case, as the sleeve 18 moves to the second position, the jacket 70 and shield 68 of the cable 60 begin to become compressively clamped within the annular region 44 between the barb 42 of the post 14 and the inner surface of the sleeve 18. In this regard, the inner surface of the sleeve 18 may be provided with an inwardly directed shoulder portion 54 to facilitate compression of the cable jacket 70 against the barb 42 of the post 14.

Also, as the sleeve 18 moves to its second position, the fingers 24 of the collar 12 are urged inwardly by the ramp 26 formed in the sleeve. As the fingers 24 bend inwardly, they compress the cable jacket 70 and shield 68 against the tubular extension 40 of the post 14 to provide additional gripping force on the cable 60.

Thus, as a result of the present invention, a collar 12 is provided that can be made of plastic, which can be molded for a less expensive manufacturing cost. Also, a connector is provided, wherein the cable 60 is prevented from being easily pulled out of the connector by three points of pressure: a) the cooperating engagement structure between the collar 12 and the sleeve 18; b) the deflected fingers 24 exerting pressure on the cable caused by the inner slanted surface 26 of the sleeve; and c) the cable jacket being compressed between the post barb 42 and the inner surface 54 of the sleeve 18.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A coaxial cable connector comprising:
a collar having a sleeve insertion end and at least one flexible finger for gripping a cable provided on said sleeve insertion end; and
an axially movable locking sleeve coupled to said collar, said locking sleeve including an internal ramped surface for deflecting said flexible finger of said collar radially inward to grip the cable as said locking sleeve is moved axially with respect to said collar.

2. A coaxial cable connector as defined in claim 1, further comprising:
an annular post disposed within said collar; and
a nut rotatably coupled to said post.

3. A coaxial cable connector as defined in claim 2, wherein said internal ramped surface of said locking sleeve deflects said flexible finger of said collar radially inward toward said post.

4. A coaxial cable connector as defined in claim 1, wherein said flexible finger includes a lateral groove formed therein to enhance flexibility of said finger.

5. A coaxial cable connector as defined in claim 1, wherein said collar includes a plurality of circumferential flexible fingers.

6. A coaxial cable connector as defined in claim 1, wherein said collar is made from a plastic material.

7. A coaxial cable connector as defined in claim 1, wherein said collar includes an outer sleeve engagement surface and said locking sleeve includes an inner collar engagement surface cooperating with said outer sleeve engagement surface of said collar to permit axial movement of said sleeve from a first position, wherein a cable is loosely retained in the connector, to a second position, wherein a cable is secured in the connector.

8. A coaxial cable connector as defined in claim 7, wherein said outer sleeve engagement surface of said collar includes first and second raised protrusions and said inner collar engagement surface includes a groove, wherein said first protrusion of said collar is seated in said groove when said sleeve is in said first position and said second protrusion of said collar is seated in said groove when said sleeve is in said second position.

9. A coaxial cable connector as defined in claim 8, wherein said first and second protrusions each include a forwardly facing perpendicular wall for preventing forward removal of the collar from the sleeve.

10. A coaxial cable connector as defined in claim 8, wherein said first and second protrusions each include a rearwardly facing chamfered wall for facilitating rearward insertion of the collar into the sleeve.

11. A coaxial cable connector as defined in claim 8, wherein said collar further includes a seal disposed between said first and second protrusions.

12. A method for terminating a coaxial cable in a connector comprising the steps of:
inserting an end of a cable into a rearward cable receiving end of a locking sleeve of the connector, said locking sleeve being movably coupled to an outer surface of a collar of the connector in a first position and having an internal ramped surface; and
axially moving said locking sleeve with respect to said collar from said first position, wherein a cable is loosely retained in the connector, to a second position, wherein a cable is secured in the connector, whereby said internal ramped surface of said sleeve deflects a flexible finger provided on said collar radially inwardly to grip an outer surface of the cable.

13. A method as defined in claim 12, wherein said collar includes first and second raised protrusions and said locking sleeve includes an internal groove, wherein said first protrusion of said collar is seated in said groove when said sleeve is in said first position and said second protrusion of said collar is seated in said groove when said sleeve is in said second position.

14. A method for terminating a coaxial cable in a connector comprising the steps of:
inserting an end of a cable into a rearward cable receiving end of a locking sleeve of the connector, said locking sleeve having an internal ramped surface;
coupling said locking sleeve to an outer surface of a collar of the connector after the cable has been inserted in the locking sleeve, said collar including a rearwardly extending flexible finger; and
axially moving said locking sleeve with respect to said collar from a first position, wherein a cable is loosely retained in the connector, to a second position, wherein a cable is secured in the connector, whereby said internal ramped surface of said sleeve deflects said flexible finger of said collar radially inwardly to grip an outer surface of the cable.

15. A method as defined in claim 14, wherein said collar includes first and second raised protrusions and said locking sleeve includes an internal groove, wherein said first protrusion of said collar is seated in said groove when said sleeve is in said first position and said second protrusion of said collar is seated in said groove when said sleeve is in said second position.
